(19) United States
(12) Patent Application Publication
(10) Pub. No.: US 2010/0089151 A1
(43) Pub. Date: Apr. 15, 2010

(54) STACKABLE MEASURING CONTAINERS WITH REMOVABLE HANDLES

(76) Inventors: Alberto Mantilla, Rego Park, NY (US); Anthony J. Baxter, Hoboken, NJ (US); Robert Nightingale, Broolklyn, NY (US); Marisol Rodriguez, Brooklyn, NY (US); Annbjorg Eide, Elmira, NY (US); Deborah A. Green-Cotton, Chicago, IL (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/248,589

(22) Filed: Oct. 9, 2008

(51) Int. Cl. G01F 19/00; B65D 25/40; B65D 25/28; B65D 21/02

(52) U.S. Cl. 73/426; 222/566; 220/759; 206/505

(57) ABSTRACT

A measuring container is provided. The measuring container has a removable handle having a proximal end and a distal end and a vessel portion having a predetermined volume. A first magnet is disposed on either the proximal end of the removable handle or the vessel portion. The first magnet removably couples the removable handle to the vessel portion.

### TECHNICAL FIELD

The invention relates to stackable measuring containers, and more particularly, to a stackable measuring cups and measuring spoons useful in cooking and preparing food.

### BACKGROUND OF THE INVENTION

When cooking and preparing foods, it is very common to utilize measuring to ensure that a proper amount of a particular ingredient is included. For instance, in many recipes specific quantities of particular ingredients are called for to successfully make the food. Further, recipes often call for different specific quantities of particular ingredients, thus many measuring containers may be required to make one dish. It is known that for ease of access and storage many measuring cups are adapted to stack within each other, that is the smaller measuring cup stacks within the next larger measuring cup. Such measuring assemblies are connected to each other via a connecting ring. These mechanisms for interconnecting a measuring container have certain inherent limitations in certain situations. For example, if only one measuring spoon is used, the entire set of measuring spoons is often washed, if the spoons are interconnected, as it may be difficult to detach the spoons from each other. Further, it is also common for a user to accidentally use the wrong measuring spoon when all of the spoon are connected by a ring. Additionally, sometimes it is difficult to quickly locate the measuring container of the size desired, as the size indication of the measuring container may be covered when the measuring containers are interconnected. Further, when cleaning the measuring container, often only the measuring portion needs to be cleaned, therefore, it would be beneficial if the handle of the measuring container could be removed so that the measuring container takes up less space in a dishwasher, or the measuring container may be more thoroughly cleaned. Therefore a need exists for a measuring container with a removable handle that may be easily separated from other different sized measuring containers and allow the size of the measuring container to be displayed when multiple measuring containers are stacked.

The present invention is provided to solve the problems discussed above and other problems, and to provide advantages and aspects not provided by prior measuring container. A full discussion of the features and advantages of the present invention is deferred to the following detailed description, which proceeds with reference to the accompanying drawings.

### SUMMARY OF THE INVENTION

According to one embodiment, A measuring container is provided. The measuring container has a removable handle having a proximal end and a distal end and a vessel portion having a predetermined volume. A first magnet is disposed on either the proximal end of the removable handle or the vessel portion. The first magnet removably couples the removable handle to the vessel portion.

According to a further embodiment, a stackable measuring container set is provided. The measuring container set includes a first measuring container and a second measuring container. The first measuring container is comprised of a first removable handle having a proximal end and a distal end and a first vessel portion having a first predetermined volume. A first magnet is disposed on either the proximal end of the first removable handle or the first vessel portion. The first magnet removably couples the first removable handle to the first vessel portion. The stackable measuring container set also includes a second measuring container. The second measuring container has a second removable handle having a proximal end and a distal end and a second vessel portion having a second predetermined volume. The second predetermined volume is different from the first predetermined volume. A second magnet is disposed on either the proximal end of the second removable handle or the second vessel portion. The second magnet removably couples the second removable handle to the vessel portion. The second magnet also cooperatively engages the first magnet to magnetically couple the first and second measuring containers in stackable together in engagement,

According to another embodiment of the invention, the first removable handle of the first measuring container and the second removable handle of the second measuring container are linearly coincident.

According to a further embodiment of the invention, the first vessel portion of the first measuring container is nested within the second vessel portion of the second measuring container.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a measuring container according to one embodiment;

FIG. 2 is a perspective view of the measuring container of FIG. 1 with the removable handle in a removed position;

FIG. 3 is a side view of the measuring container of FIG. 1;

FIG. 4 is a side view of the measuring container of FIG. 1 with the removable handle in a removed position;

FIG. 5 is a cross sectional view taken along line 5-5 of FIG. 3;

FIG. 6 is a perspective view of a set of measuring cups according to one embodiment;

FIG. 7 is a perspective view of a measuring spoon assembly according to one embodiment;

FIG. 8 is a perspective view of the measuring spoon assembly of FIG. 7 with the removable handle in a removed position;

FIG. 9 is a side view of the measuring spoon assembly of FIG. 7;

FIG. 10 is a side view of the measuring spoon assembly of FIG. 7 with the removable handle in a removed position;

FIG. 11 is a cross sectional view taken along line 11-11 of FIG. 9;

FIG. 12 is a perspective view of a set of measuring spoons according to one embodiment.

The components in the drawings are not necessarily to scale, emphasis instead being placed upon clearly illustrating the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

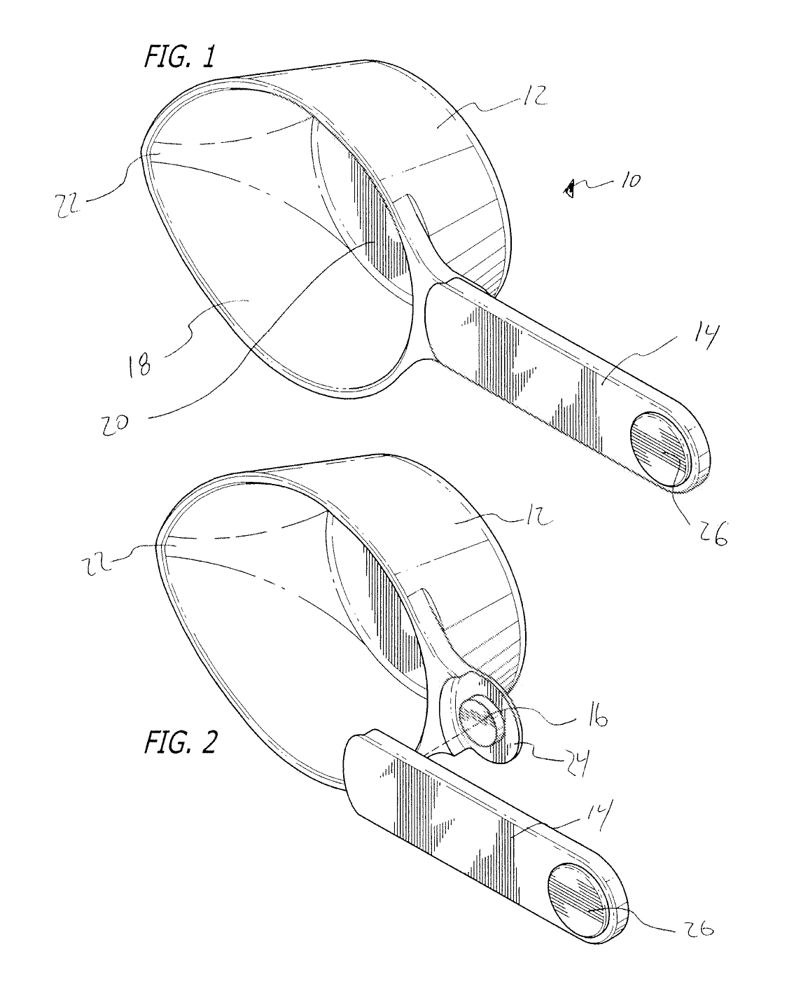

According to present invention, measuring containers is provided. It will be understood by those of skill in the art that the measuring containers discussed herein can be measuring cups, measuring spoon or any other measuring receptacle without departing from the present invention. As shown in FIGS. 1-5, the measuring container 10 (i.e., measuring cup) comprises a vessel portion 12, a removable handle 14, and a magnet 16. The vessel portion 12 is designed to hold a predetermined volume of material. The vessel portion 12 has a continuous side wall 18 that extends upwardly from a base 20. The side wall 18 forms a spout portion 22 at one end of a periphery of the side wall 18. The spout portion 22 assists in pouring material from the measuring container, particularly liquid materials. As shown in FIG. 1, the spout portion 22 extends the side wall 18 outwardly from the center of the vessel portion 12 in a manner that creates an area that helps to direct the flow of material out of the vessel portion 12.

A magnet 16 is disposed on either the proximal end of the removable handle 14 or the vessel portion 12 of the measuring container 10. The magnet 16 acts to removably couple the removable handle 14 to the vessel portion 12. In one embodiment of the invention shown in FIG. 2, the vessel portion 12 additionally has a magnet support 24. The magnet support 24 provides a support for the magnet 16, as well as a surface to support the handle portion 14.

The handle 14 extends from a periphery of the sidewall 18 of the vessel portion 12 in the opposite direction of the spout portion 22. The handle portion 14 has an informational indicia 26 that displays the volume of the vessel portion 12. The handle portion 14 additionally has a recess 28 that fits over the magnet 16. The length of the handle 14 allows a user to pour the contents out of the vessel portion 12. According to one embodiment of the present invention, the removable handle 14 has a predetermined length that has corresponding relationship to the predetermined volume of the vessel portion 12 of the measuring container 10.

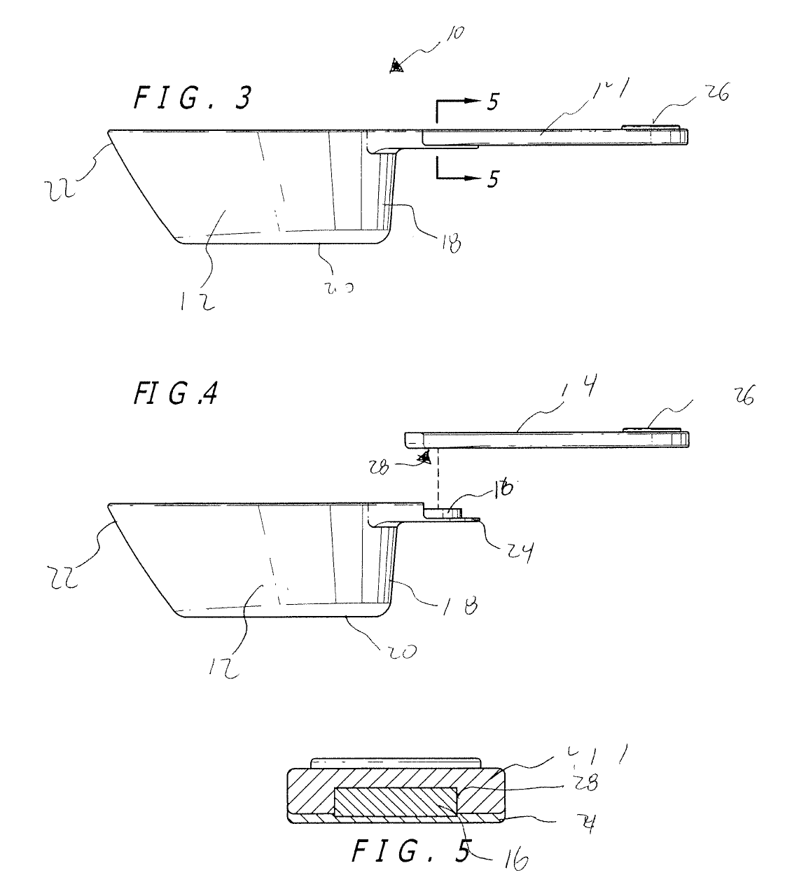

The handle 14 is removable secured to the vessel portion 12 via magnetic force provided by the magnet 16. The handle 14 is brought near the magnet 16 and the magnetic force attracts the handle 14 to the magnet 16. As the magnet 16 is mounted to the vessel portion 12 at the magnet support 24, the recess 28 allows the handle 14 to fit over the magnet 16, thus contacting the magnet support 24 of the vessel portion 12. As shown in FIG. 3, the area where the handle 14 attaches to the vessel portion 12 forms a top surface that is generally planar to a top surface of both the vessel portion 12 and the handle 14.

The handle portion 14 additionally has an informational indicia 26. The informational indicia indicates the volume of the vessel portion 12 of the measuring container 10. The informational indicia may simply display a numerical indication of the volume of the vessel portion 12. It is further contemplated that in addition to a numerical display, the informational indicia may vary in size based on the volume of the vessel portion 12. That is, the informational indicia is larger when the volume of the vessel portion 12 is greater. As shown in FIGS. 1-5, the information indicia are disposed on an indicia surface 26 which is disposed on the top surface of the removable handle. The indicia surface 26 that is defined by an elevated member having a predetermined height relative to the top surface of the removable handle 14.

According to the present invention, the magnet 16 produces a magnetic force that is sufficient to secure the handle 14 to the vessel portion 12 during normal use of the measuring container 10, however, the magnetic force may be overcome to remove the handle 14 from the vessel portion 12. When the handle 14 is removed, the vessel portion 12 may be cleaned, without having to clean the handle portion 14. The removal of the handle 14 allows the cup portion to take up less space in a dishwasher, or simply allows a user to more thoroughly clean the vessel portion 12.

As shown in FIG.5, the magnet 16 is formed into the magnet support 24 of the vessel portion 12. It is further contemplated that the magnet 16 may simply sit on a surface of the magnet support 24, or the magnet 16 may be connected to the handle portion 14 instead of the vessel portion 12.

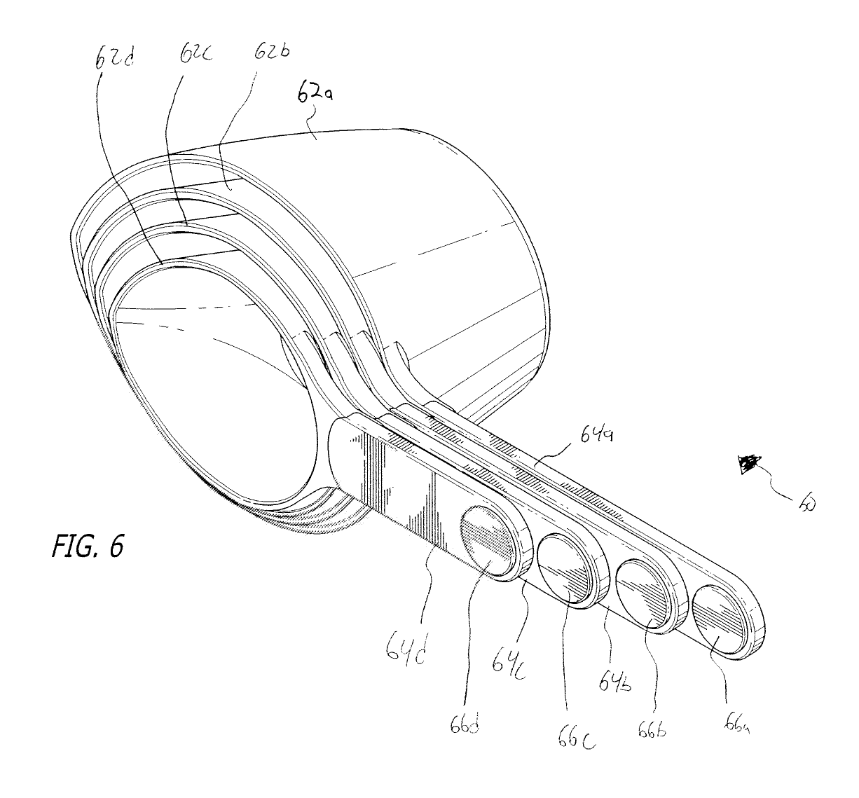

Turning now to FIG. 6, a set of measuring containers 60 is shown. The set 60 has four measuring cup assemblies, 62a, 62b, 62c, and 62d ranging in size from a largest measuring cup 62a to a smallest measuring cup 62d. The measuring containers 62a-62d are generally identical to the measuring container 10 shown in FIGS. 1-5, except the predetermined volume of the cup portion varies. Each of the measuring containers 62a-62d has a handle portion 64a-64d. The length of the handle portion 64a-64d varies based on the predetermined volume of the measuring containers 62a-62d, with the largest measuring cup 62a having the longest handle portion 64a, and the smallest measuring cup 62d having the shortest handle portion 64d. Each of the handle portions 64a-64d additionally has an informational indicia 66a-66d. The varying length of the handle portion 64a-64d allows each of the informational indicia 66a-66d to be displayed even when the measuring containers 62a-62d are stacked. Displaying each of the informational indicia 66a-66d allows a user to quickly find the desired measuring container for a particular purpose based on the volume of the measuring cup assembly 62a-62d.

The handle portions 64a-64d are linearly arranged when the measuring containers 62a-62d are stacked together. In other words, the removable handle of the measuring containers are linearly coincident. Furthermore, when the measuring containers 62a-62d are stacked together, the vessel portion of the each measuring container is nested within the second vessel portion of the second measuring container.

The measuring containers 62a-62d of the set of measuring containers 60 is held together by the magnets (not shown) of each of the measuring containers 62a-62d. That is, for example, the magnetic force created by the magnet of the second measuring cup assembly 62b acts on both the first measuring cup assembly 62a and the third measuring cup assembly 62c to hold the measuring cup assemblies 62a-62c together. The magnetic force may be overcome by the user to remove the measuring containers 62a-62d from the set of measuring containers 60.

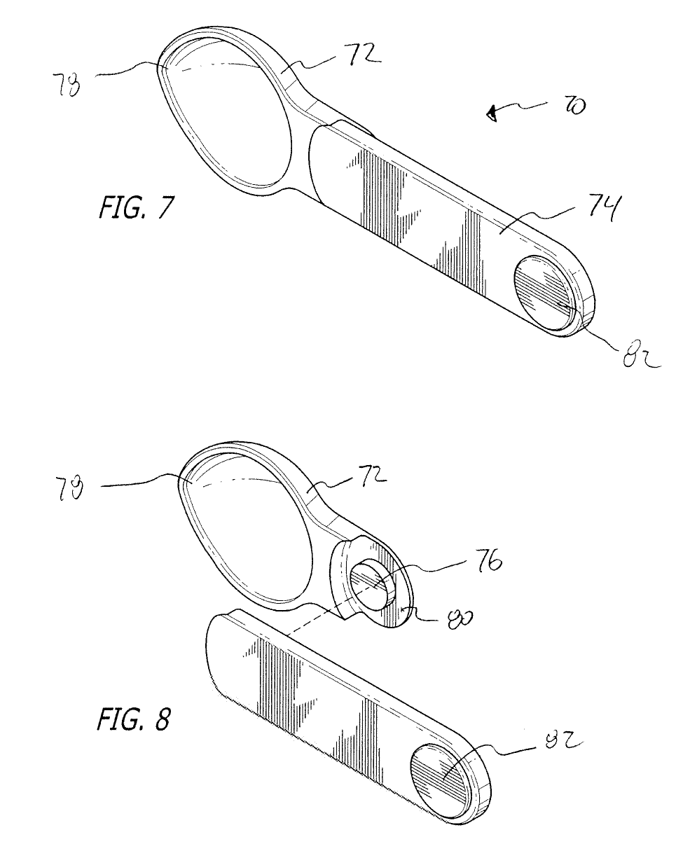

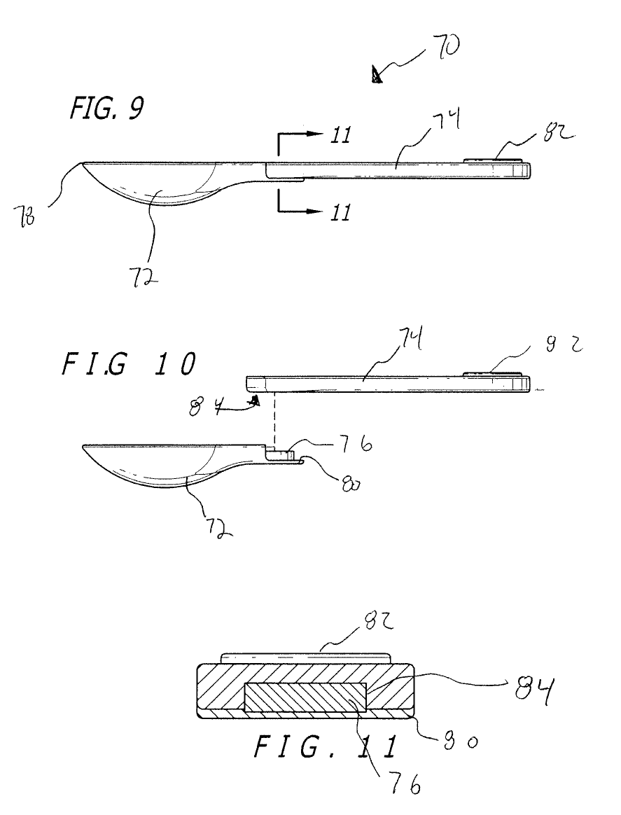

According to another embodiment as shown in FIGS. 7-11, a measuring spoon assembly 70 is provided. The measuring spoon assembly 70 comprises a spoon portion 72, a removable handle 74, and a magnet 76. The spoon portion 72 is designed to hold a predetermined volume of material. The spoon portion 72 forms a spout portion 78 at one end of a periphery of spoon portion 72. The spout portion 78 assists in pouring material from the measuring spoon assembly 70, particularly liquid materials. As shown in FIG. 7, the spout portion 78 outwardly from a periphery of the spoon portion 72 in a manner that creates an area that helps to direct the flow of material out of the spoon portion 72.

As seen in FIG. 8, the spoon portion 72 additionally has a magnet support 80. The magnet support 80 provides a support for the magnet 76, as well as a surface to support the handle portion 74.

The handle portion 74 extends from a periphery of the spoon portion 72 in the opposite direction of the spout portion 78. The handle portion 74 has an informational indicia 82 that displays the volume of the spoon portion 72. The handle portion 74 additionally has a recess 84 that fits over the magnet 76. The length of the handle 74 allows a user to pour the contents out of the spoon portion 72.

The handle 74 is removable secured to the spoon portion 72 via magnetic force provided by the magnet 76. The handle 74 is brought near the magnet 76 and the magnetic force attracts the handle 74 to the magnet 76. As the magnet 76 is mounted to the spoon portion 72 at the magnet support 80, the recess 84 allows the handle 74 to fit over the magnet 76, thus contacting the magnet support 80 of the spoon portion 72.

The handle portion 74 additionally has an informational indicia 82. The informational indicia 82 indicates the volume of the spoon portion 72 of the measuring spoon assembly 70. The informational indicia 82 may simply display a numerical indication of the volume of the spoon portion 72. It is further contemplated that in addition to a numerical display, the informational indicia 82 may vary in size based on the volume of the spoon portion 72. That is, the informational indicia 82 is larger when the volume of the spoon portion 72 is greater.

The magnet 76 produces a magnetic force that is sufficient to secure the handle 74 to the spoon portion 72 during normal use of the measuring spoon assembly 70, however, the magnetic force may be overcome to remove the handle 74 from the spoon portion 72. When the handle 74 is removed, the spoon portion 72 may be cleaned, without having to clean the handle portion 74. The removal of the handle 74 allows the spoon portion to take up less space in a dishwasher, or simply allows a user to more thoroughly clean the spoon portion 72.

As shown in FIG. 11, the magnet 76 is formed into the magnet support 80 of the spoon portion 72. It is further contemplated that the magnet 76 may simply sit on a surface of the magnet support 80, or the magnet 76 may be connected to the handle portion 74 instead of the cup portion 72.

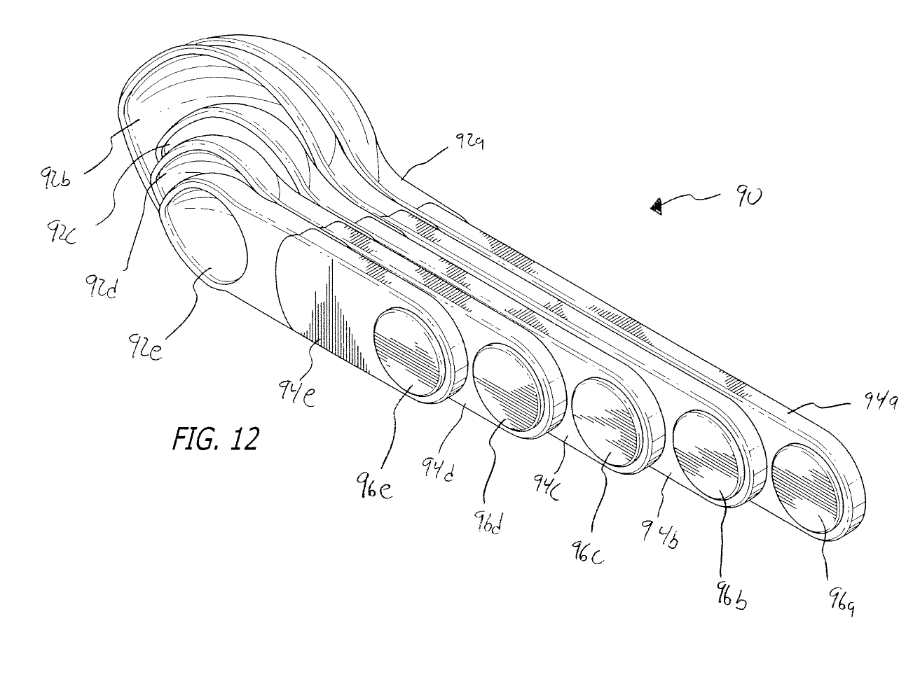

Turning now to FIG. 12, a set of measuring spoons 90 is shown. The set 90 has five measuring spoon assemblies, 92a, 92b, 92c, 92d, and 92e ranging from a largest spoon 92a to a smallest spoon 92e. The measuring spoon assemblies 92a-92e are generally identical to the measuring spoon assembly 70 shown in FIGS. 7-11, except the volume of the spoon portion varies. Each of the measuring spoon assemblies 92a-92e has a handle portion 94a-94e. The length of the handle portion 94a-94e varies based on the volume of the measuring spoon assemblies 92a-92e, with the largest measuring spoon 92a having the longest handle portion 94a, and the smallest measuring spoon 92e having the shortest handle portion 94e. Each of the handle portions 94a-94e additionally has an informational indicia 96a-96e. The varying length of the handle portion 94a-94e allows each of the informational indicia 96a-96e to be displayed even when the measuring spoon assemblies 92a-92e are stacked. Displaying each of the informational indicia 96a-96e allows a user to quickly find the desired measuring spoon assembly for a particular purpose based on the volume of the measuring spoon assembly 92a-92e.

The measuring spoon assemblies 92a-92e of the set of measuring spoons 90 is held together by the magnets (not shown) of each of the measuring spoon assemblies 92a-92e. That is, for example, the magnetic force created by the magnet of the second measuring spoon assembly 92b acts on both the first measuring spoon assembly 92a and the third measuring spoon assembly 92c to hold the measuring spoon assemblies 92a-92c together. The magnetic force may be overcome by the user to remove the measuring spoon assemblies 92a-92e from the set of measuring spoons 90.

While the specific embodiments have been illustrated and described, numerous modifications come to mind without significantly departing from the spirit of the invention, and the scope of protection is only limited by the scope of the accompanying Claims.

What is claimed is:

1. A measuring container comprising:
a removable handle having a proximal end and a distal end;
a vessel portion having a predetermined volume; and
a first magnet disposed on one of either the proximal end of the removable handle and the vessel portion, the first magnet removably coupling the removable handle to the vessel portion.

2. The measuring container of claim 1, wherein the vessel portion has a spout portion.

3. The measuring container of claim 1, wherein the first magnet is disposed in a recess formed in one of either the proximal end of the removable handle and the vessel portion, the recess being configured to cooperatively receive the other of the proximal end of the removable handle and the vessel portion.

4. The measuring container of claim 1, wherein the removable handle and the vessel portion cooperatively define a top surface at a connection region, the top surface of the connection region being generally planar to a top surface of the removable handle and a top surface of the vessel portion.

5. The measuring container of claim 4 further comprising an indicia surface disposed on the top surface of the removable handle.

6. The measuring container of claim 5 wherein the indicia surface is defined by an elevated member having a predetermined height relative to the top surface of the removable handle.

7. The measuring container of claim 1, wherein the magnet is at least partially formed in the vessel portion.

8. The measuring container of claim 1, wherein the removable handle has a predetermined length, the predetermined length having a corresponding relationship to the predetermined volume of the vessel portion.

9. A stackable measuring container set comprising:
a first measuring container comprising a first removable handle having a proximal end and a distal end, a first vessel portion having a first predetermined volume, and a first magnet disposed on one of either the proximal end of the first removable handle and the first vessel portion, the first magnet removably coupling the first removable handle to the first vessel portion; and
a second measuring container comprising a second removable handle having a proximal end and a distal end, a second vessel portion having a second predetermined volume, and a second magnet disposed on one of either the proximal end of the second removable handle and the second vessel portion, the second magnet removably coupling the second removable handle to the vessel portion and cooperatively engaging the first magnet to magnetically couple the first and second measuring containers in stackable engagement.

10. The stackable measuring container set of claim 9, wherein the first measuring container comprises a first measuring cup, and the second measuring container comprises a measuring second cup.

11. The stackable measuring container set of claim 9, wherein the first measuring container comprises a first measuring spoon and the second measuring container comprises a second measuring spoon.

12. The stackable measuring container set of claim 9 further comprising a first indicia surface disposed on a top surface of the first removable handle of the first measuring container, the first indicia indicating the first volume, and a second indicia surface disposed on a top surface of the second removable handle of the second measuring container, the first indicia indicating the second volume.

13. The stackable measuring container set of claim 12 wherein the at least one of the first and second indicia surface is defined by an elevated member having a predetermined height relative to the top surface of the corresponding removable handle, wherein the first indicia and the second indicia are both visible when the first measuring container is coupled in stackable engagement to the second measuring container.

14. The stackable measuring container set of claim 14, wherein the first removable handle and the second removable handle are linearly coincident with the second measuring container.

15. The stackable measuring container set of claim 14, wherein the first vessel portion of the first measuring container is nested within the second vessel portion of the second measuring container.
